(19) United States
(12) Patent Application Publication
(10) Pub. No.: US 2013/0126467 A1
(43) Pub. Date: May 23, 2013

(54) METHOD FOR MANUFACTURING CONDUCTIVE LINES WITH SMALL LINE-TO-LINE SPACE

(71) Applicants: Jing-feng Xue, Shenzhen (CN); Jehao Hsu, Shenzhen (CN)

(72) Inventors: Jing-feng Xue, Shenzhen (CN); Jehao Hsu, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/379,852

(22) PCT Filed: Nov. 24, 2011
(86) PCT No.: PCT/CN2011/082827

§ 371 Date: Dec. 21, 2011

(30) Foreign Application Priority Data
Nov. 18, 2011 (CN) 201110369499.X

(51) Int. Cl. H01B 13/00

(52) U.S. Cl. 216/17

(57) ABSTRACT

The present invention discloses a method for manufacturing conductive lines with small line-to-line space. The method for manufacturing conductive lines is to coat photoresist on a conductor layer firstly, after exposure and development treatments, then further perform an ashing treatment to completely remove the corresponding part of the photoresist that is corresponding to the exposure area, and then perform an etching step for the conductor layer to form the required conductive lines. The method provided by the present invention can manufacture wire patterns that meet the requirement of small line-to-line space under a condition that the exposure apparatus has limited exposure accuracy.

### FIELD OF THE INVENTION

The present invention relates to photo-lithography technologies, and more particularly to a method for manufacturing conductive lines with small line-to-line space.

### BACKGROUND OF THE INVENTION

Generally speaking, in a process of manufacturing metallic wires of a liquid crystal panel, a metal layer will be formed on a glass substrate by sputtering coating, and then a photoresist will be coated on the metal layer. The photoresist will become a patterned photoresist layer after an exposure and development treatment. A part of the metal layer which is not covered by the photoresist layer will be removed by an etching treatment. In the end, the patterned photoresist layer will be removed and thereby form the required metallic wires.

Using a photo-lithography technology can expose the photoresist into different wire patterns, however, when the line-to-line space from one wire to another in the wire patterns is relatively small, the photoresist may not have sufficient exposure due to low transmittance of light. After a development treatment, as show in FIG. 1, a certain part of the photoresist which should have been removed still have some residues, and thereby causes blocks of the photoresist layer 900 are still connected together, and makes the metallic layer 910 underneath to be unable to form a desired wire pattern after the photo-lithography works. Therefore, effective line-to-line space of a wire pattern is often limited to the exposure accuracy of the exposure apparatus.

However, in the production design for a certain liquid crystal display device, the wire pattern sometimes needs to use a relative small line-to-line space to enhance the properties of products, for example, the light transmittance of liquid crystal. At present time, the minimum exposure accuracy of any 8.5 generation exposure apparatus is limited to its own resolving ability (about 3 micrometers), hence it is unable to produce a product having line-to-line space which is less than the exposure accuracy of the exposure apparatus.

Hence, it is necessary to provide a method for manufacturing conductive lines with small line-to-line space to overcome the problems existing in the conventional technology.

### SUMMARY OF THE INVENTION

In view of the shortcomings described in the prior art, a primary object of the invention is to provide a method for manufacturing conductive lines with small line-to-line space that add a step of ashing treatment on photoresist after a mask exposure and development treatment to remove residues of photoresist that are not completely removed during the development treatment due to the limitation of exposure accuracy.

To achieve the above object, the present invention provides a method for manufacturing conductive lines with small line-to-line space, and the method for manufacturing the conductive lines comprises following steps of:

S1: providing a conductor layer;

S2: coating a photoresist layer on the conductor layer;

S3: performing exposure and development treatments to the photoresist layer;

S4: performing an ashing treatment to the photoresist layer to remove photoresist residue corresponding to the exposure area to pattern the photoresist layer; and

S5: performing an etching treatment to the conductor layer and remove the patterned photoresist layer to form conductive lines.

In one embodiment of the present invention, the step S3 further includes the following steps of:

using a mask to partially expose the photoresist layer; and

performing a development treatment to the photoresist layer to initially remove the part of the photoresist layer that are corresponding to the exposure area.

In one embodiment of the present invention, the mask has a slot having a width that is less than exposure accuracy of an exposure apparatus.

In one embodiment of the present invention, the conductor layer is an indium tin oxide layer or a metal layer.

In one embodiment of the present invention, the ashing treatment is to carbonize the photoresist layer by heating or laser irradiation to remove the photoresist residue.

The present invention further provides a method for manufacturing conductive lines with small line-to-line space, and the method for manufacturing the conductive lines comprises following steps of:

S1: providing a conductor layer;

S2: coating a photoresist layer on the conductor layer;

S3: performing exposure and development treatments to the photoresist layer, wherein using a mask to partially expose the photoresist layer, and then performing a development treatment to the photoresist layer to initially remove the part of the photoresist layer that are corresponding to the exposure area;

S4: performing an ashing treatment to the photoresist layer to remove photoresist residue corresponding to the exposure area to pattern the photoresist layer, wherein the ashing treatment is to carbonize the photoresist layer by heating or laser irradiation to remove the photoresist residue; and

S5: performing an etching treatment to the conductor layer and remove the patterned photoresist layer to form conductive lines.

The present invention is mainly to add a step of ashing treatment on photoresist after mask exposure and development treatments to remove residue of photoresist that are not completely removed during the development treatment due to the limitation of exposure accuracy, such that conductive lines with smaller line-to-line space can be made on a substrate even using an exposure apparatus having limited exposure accuracy.

### DESCRIPTION OF THE DRAWINGS

FIG. 1 is a schematic view showing that residue of photoresist remain after development treatment due to the limitation of exposure accuracy during a process of manufacturing metallic wires of liquid crystal panel according to the prior art;

FIGS. 2A to 2E are manufacturing schematic views of a preferred embodiment of achieving a method for manufacturing conductive lines with small line-to-line space in accordance with the present invention; and

FIG. 3 is a flow chart of a preferred embodiment of achieving the method for manufacturing conductive lines with small line-to-line space in accordance with the present invention.

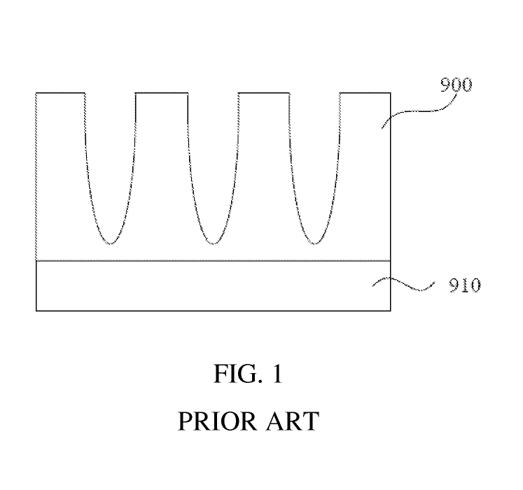

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

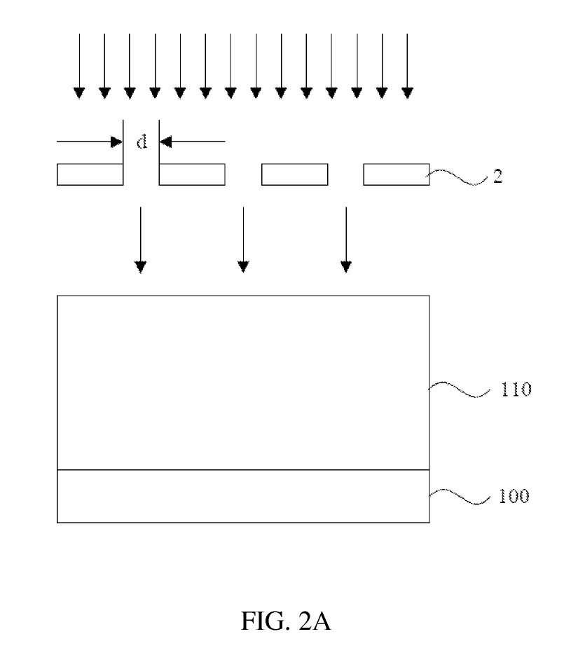

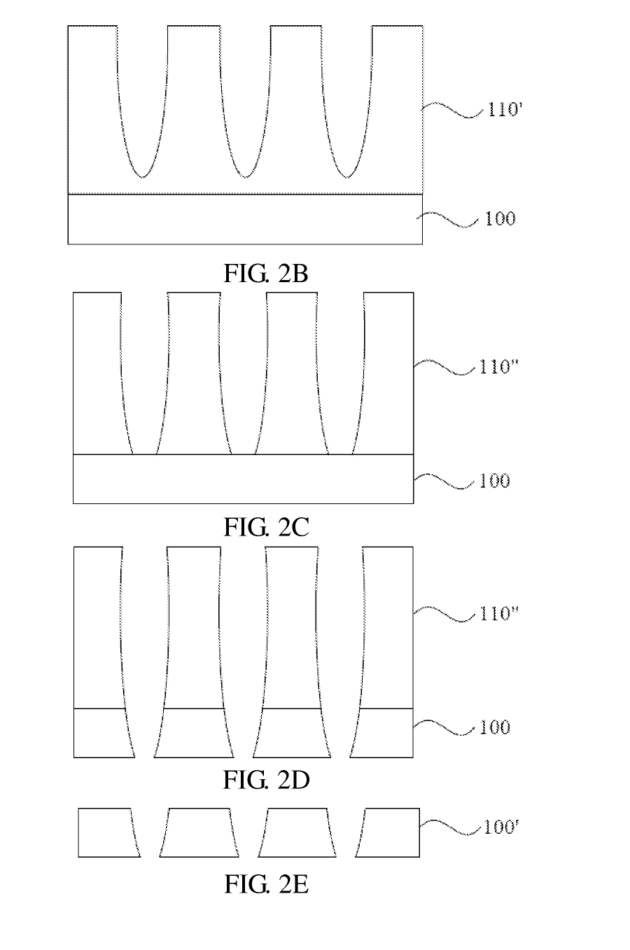

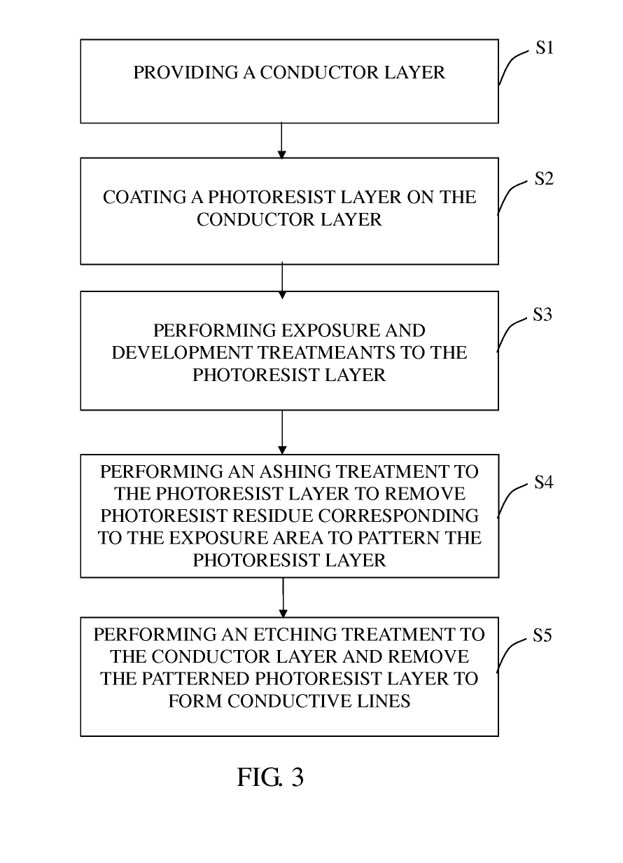

Referring to FIG. 3 and cooperating with FIGS. 2A to 2E, wherein FIG. 3 is a flow chart of a preferred embodiment of achieving the method for manufacturing conductive lines with small line-to-line space in accordance with the present invention, and FIGS. 2A to 2E are manufacturing schematic views of a preferred embodiment of achieving the method for manufacturing conductive lines with small line-to-line space in accordance with the present invention. The method for manufacturing conductive lines with small line-to-line space of the present invention comprises following steps:

S1: providing a conductor layer 100; (as shown in FIG. 2A)

S2: coating a photoresist layer 110 on the conductor layer 100;

S3: performing exposure and development treatments to the photoresist layer 110, wherein as shown in FIG. 2A, the step may use a patterned mask 2 to partially expose the photoresist layer 110; as shown in FIG. B, when slots of the mask 2 in FIG. 2A for lights to pass through have a width d less than the exposure accuracy of an exposure apparatus (for example, 3 micrometers), the photoresist layer 110′ after the development treatment will still have photoresist residue corresponding to the position of the exposure area;

S4: performing an ashing treatment to the photoresist layer 110′ to remove the photoresist residue corresponding to the exposure area to pattern the photoresist layer; as shown in FIG. 2C, after the ashing treatment, the photoresist residue corresponding to the exposure area is removed and a desired patterned photoresist layer 110″ is formed; and the ashing treatment of this step is to carbonize the photoresist layer by heating or laser irradiation to achieve the object of removing the photoresist residue;

S5: performing an etching treatment to the conductor layer 100 and remove the patterned photoresist layer 110″ to form conductive lines. As shown in FIG. 2D, remove the exposed part of the conductor layer 100 by the etching treatment to correspondingly pattern the conductor layer 100; and in the end, as shown in FIG. 2E, removes the patterned photoresist layer 110″ and then the desired line patterns 100′ are formed.

The mask 2 used in the step S3 preferably has a slot having a width that is less than exposure accuracy of an exposure apparatus. Furthermore, the conductor layer 100 is preferably an indium tin oxide layer or a metal layer, but is not limited thereto.

It can be known from the above description, comparing with the conventional method for manufacturing conductive lines which is limited to the limitation of exposure accuracy and unable to form wire patterns having a smaller line-to-line space, the method for manufacturing conductive lines of the present invention further performs an ashing treatment after exposure and development treatments to remove residues of photoresist that are not completely removed during the development treatment due to the limitation of exposure accuracy, so as to further manufacture conductive lines with smaller line-to-line space on a substrate. Therefore, the method for manufacturing conductive lines with small line-to-line space can still manufacture wire patterns that meet the requirement of small line-to-line space under a condition that the exposure apparatus has limited exposure accuracy.

The present invention has been described with a preferred embodiment thereof and it is understood that many changes and modifications to the described embodiment can be carried out without departing from the scope and the spirit of the invention that is intended to be limited only by the appended claims.

1. A method for manufacturing conductive lines with small line-to-line space, characterized in that: the method for manufacturing conductive lines comprises steps of:
S1: providing a conductor layer;
S2: coating a photoresist layer on the conductor layer;
S3: performing exposure and development treatments to the photoresist layer, wherein using a mask to partially expose the photoresist layer, and then performing a development treatment to the photoresist layer to initially remove the part of the photoresist layer that are corresponding to the exposure area;
S4: performing an ashing treatment to the photoresist layer to remove photoresist residue corresponding to the exposure area to pattern the photoresist layer, wherein the ashing treatment is to carbonize the photoresist layer by heating or laser irradiation to remove the photoresist residue; and
S5: performing an etching treatment to the conductor layer and remove the patterned photoresist layer to form conductive lines.

2. A method for manufacturing conductive lines with small line-to-line space, characterized in that: the method for manufacturing conductive lines comprises steps of:
S1: providing a conductor layer;
S2: coating a photoresist layer on the conductor layer;
S3: performing exposure and development treatments to the photoresist layer;
S4: performing an ashing treatment to the photoresist layer to remove photoresist residue corresponding to the exposure area to pattern the photoresist layer; and
S5: performing an etching treatment to the conductor layer and remove the patterned photoresist layer to form conductive lines.

3. The method for manufacturing conductive lines with small line-to-line space as claimed in claim 2, characterized in that: the step S3 further includes the following steps of:
using a mask to partially expose the photoresist layer; and
performing a development treatment to the photoresist layer to initially remove the part of the photoresist layer that are corresponding to the exposure area.

4. The method for manufacturing conductive lines with small line-to-line space as claimed in claim 2, characterized in that: the mask has a slot having a width that is less than exposure accuracy of an exposure apparatus.

5. The method for manufacturing conductive lines with small line-to-line space as claimed in claim 2, characterized in that: the conductor layer is an indium tin oxide layer or a metal layer.

6. The method for manufacturing conductive lines with small line-to-line space as claimed in claim 2, characterized in that: the ashing treatment is to carbonize the photoresist layer by heating or laser irradiation to remove the photoresist residue.
